(19) United States
(12) Patent Application Publication
(10) Pub. No.: US 2004/0137416 A1
(43) Pub. Date: Jul. 15, 2004

(54) System and method using adaptive learning components to enhance target advertising and customize system behavior

(76) Inventors: Yue Ma, West Windsor, NJ (US); Chieh-Chung Chang, Monmouth Junction, NJ (US); Alan Kaplan, Princeton, NJ (US); Rajesh Bhagwandas Khandelwal, Bridgewater, NJ (US); Eran Sitnik, Ossining, NY (US)

Correspondence Address: HARNESS, DICKEY & PIERCE, P.L.C., P.O. BOX 828, BLOOMFIELD HILLS, MI, 48303, US

(21) Appl. No.: 10/392,540

(22) Filed: Mar. 20, 2003

Related U.S. Application Data
(60) Provisional application No. 60/370,449, filed on Apr. 5, 2002.

(51) Int. Cl. G09B 25/00

(52) U.S. Cl. 434/365; 434/162

(57) ABSTRACT

An adaptive learning system learns and adapts to behavior of a user enjoying media content via a handheld device. The system includes a user interface provided to the handheld device and operable to receive user input, and a media delivery mechanism provided to the user interface and operable to deliver media content to the user in response to the user input. In further aspects, the system includes a data store provided to the handheld device and operable to record information relating to user consumption of media content, wherein the user consumption occurs in connection with delivering electronic media content.

### FIELD OF THE INVENTION

The present invention relates to the optimization of advertising viewership based on a user's behavior. More specifically, the present invention discloses a method and system for adapting advertising content based on a user's interaction with a handheld device.

### BACKGROUND AND SUMMARY OF THE INVENTION

The present invention implements an adaptive learning system cooperating with a handheld control device to capture a user's viewing habits and to optimize a user's interaction with programming content. The handheld device, which provides remote control and interactive television functionality, uses an adaptive learning algorithm to interpret viewing habits and use the acquired data to adjust advertising accordingly. Furthermore, the handheld device is operable to use adaptive learning functions to adjust its own interactive components based on a one or more user's behavior, and can adjust to preferences of a particular users among multiple users of the handheld control device.

Generally, a major obstacle to optimized broadcasting and advertising is a user's ability to quickly change the viewed channel using a remote control, especially when advertising is being aired. Ideally, both advertisers and broadcasters want as many viewers as possible during advertising content. In order to maximize viewership during advertising, it is advantageous to all parties involved to know the typical viewer responses to various content.

By using an adaptive learning system on a handheld device that is designed to capture a user's viewing habits, a broadcaster or advertiser can better appreciate the value of different programming content. The user's viewing habits are captured by the handheld device and then conveyed to the broadcaster or advertiser for analysis. With this data readily available, a broadcaster or advertiser is more knowledgeable of a viewership's characteristics and can dynamically customize advertisements to suit a viewer's interests.

The adaptive learning system according to the present invention is advantageous over previous adaptive learning systems in that it enables multiple users to control media delivery devices and consume media content according to the preferences of a particular user. It is further advantageous in that it provides the aggregated and/or individual user preferences to providers of media content, and user profiles can be associated with the preferences by virtue of the device being able to identify a particular user employing the handheld device to consume media content.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is one embodiment of the handheld control device.

FIG. 2 is one embodiment of the system architecture of the present invention.

FIGS. 3 and 4 describe one embodiment of an advertisement reward system used with the present invention.

FIG. 5 is one embodiment of an adaptive learning system for a customizable handheld device.

FIGS. 6-10 are flow diagrams describing an adaptive handwriting search method according to the present invention.

### DETAILED DESCRIPTION OF THE PREFERRED EMBODIMENTS

The following description of the preferred embodiments is merely exemplary in nature and is in no way intended to limit the invention, its application, or uses.

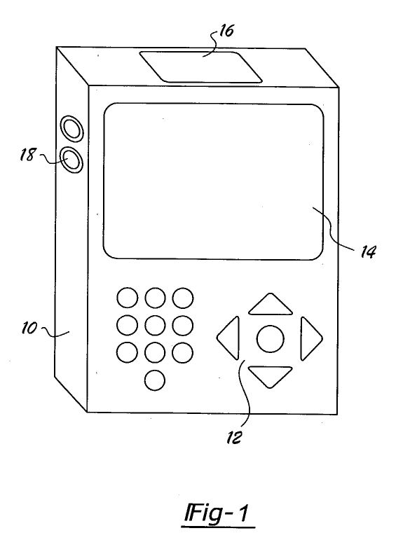

With reference to FIG. 1, one embodiment of a handheld control device operable to implement the present invention is illustrated. The control device generally includes a housing assembly 10, a user interface 12, and a display screen 14. A user interacts with the control device by way of the user interface 12. The user interface may provide means for manipulating applications and data on the control device itself, as well as conventional interaction with electronic devices such as televisions, VCR's, and DVD players. In addition, a user may interact with the control device by direct contact with touch elements on the display screen 14 using a stylus pen. The handheld control device also includes a communication means 16 for transmitting and receiving wireless data.

In one embodiment, the handheld control device is a personal data assistant (PDA).

In another embodiment, the handheld control device includes a PDA stylus pen for handwriting input.

In another embodiment, the handheld control device includes additional communications means 18 for uploading and downloading data to and from a personal computer.

In yet another embodiment, the handheld control device includes additional communication means for transmitting and receiving wireless Internet data.

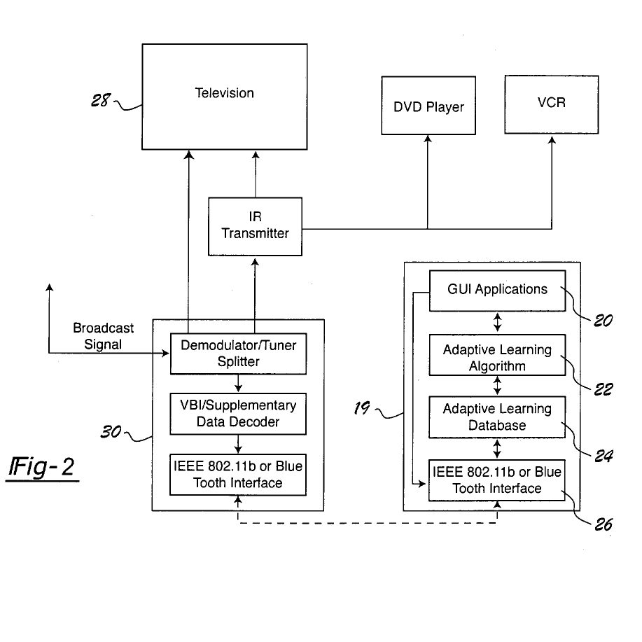

With reference to FIG. 2, one embodiment of the system architecture is described. The handheld device 19 comprises a graphical user interface (GUI) application 20, an adaptive learning algorithm 22, an adaptive learning database 24, and an IEEE 802.11b or Bluetooth interface 26. In yet another embodiment, the handheld includes peripherals to access external media such as an SD card. In yet another embodiment, the handheld includes a TV tuner and supplementary data decoder as further described in U.S. Provisional Application No. 60/430,292, filed on Dec. 2, 2002; the disclosure of the above application is incorporated herein by reference.

The user interacts with the handheld device 19 through the GUI application 20. The applications 20 present media content extracted from a broadcast signal, such as program data, or downloaded from the Internet to the user for viewing and manipulation. Using the applications 20, the user can request such information as electronic program guides (EPG's), supplementary program information, advertisement or product information, news highlights, or sporting event scores and statistics. In addition, the applications 20 may provide the user with games related to currently viewed content, such as trivia, coupon opportunities, and the ability to play along with game shows.

The adaptive learning algorithm 22 intercepts application requests and commands from the user. The algorithm 22 is a software module that compiles data relating to a user's behavior. For instance, the algorithm 22 can determine what program a user was viewing during which an advertisement was viewed, whether or not the user changed the channel during this advertisement, what channel the viewer changed to, or what advertisements a user regularly watches. The algorithm 22 analyzes this data and organizes it for optimal storage in the adaptive learning database 24.

In one embodiment, the algorithm further identifies a particular user during operation based, for example, on biometric handwriting analysis of handwritten user search queries input via a touch screen and stylus; more information on the handwriting search process and biometric identification can be found in U.S. Provisional Application No. 60/370,496, filed on Apr. 5, 2002; the disclosure of the above application is incorporated herein by reference. Yet further information on the handwriting search process and biometric identification can be found in U.S. Provisional Application No. 60/370,561, filed on Apr. 5, 2002; the disclosure of the above application is incorporated herein by reference. It should be readily understood that the user identification can alternatively take place through use of fingerprint analysis or retinal scan, or through speech recognition-based search and biometric voiceprint analysis. It should further be readily understood that the identification can alternatively take place through user selection of an enrolled profile icon displayed on the device touchscreen that the user employs to activate user preferences.

The device can use this identification to store user behavior data in association with a particular, identified user, and can even collect user profile information (age, sex, occupation) for storage as well; thus database 24 may be partitioned as needed to store information for different users. The adaptive learning database 24 stores the user behavior data on the handheld device 19 for later application by the algorithm 22. Alternatively, the user behavior data can be stored on the network and can be shared by other devices on the network.

The wireless interface 26 transmits user requests and commands to the television 28. In one embodiment, the handheld device 19 transmits user requests directly to the television 28. In another embodiment, the handheld device 19 transmits requests to an interface unit 30, which in turn relays requests to the television 28 in an IR format. The interface unit 30 is a hardware device that resides in a fixed location relative to the television 30 and processes handheld device requests. In addition, the compiled user behavior data and any associated user profile from the algorithm database 24 is transmitted to the interface unit 30, from which it is then sent back to the broadcaster for analysis. In yet another embodiment, the handheld device communicates the information to advertisers via the Internet or other communications network. With access to this information, a broadcaster or advertiser can dynamically adjust advertising content to correspond to a user's viewing habits.

In one embodiment, the advertiser develops different advertising content for different user demographics, and the device is adapted to identify the particular user, identify a user demographic associated with received advertising content, and deliver received advertising content by matching a user profile of the particular user to the user demographic of the advertising content. In another embodiment, the device communicates an identification of a particular user, such as a user profile, currently consuming media content to an advertiser, and the advertiser adjusts the advertising content in real time based on a particular user profile, and/or based on a user demographic developed from an aggregate of current user profiles.

In another embodiment, the adaptive algorithm 22 resides on the interface unit 30 to conserve processing resources on the handheld device 19.

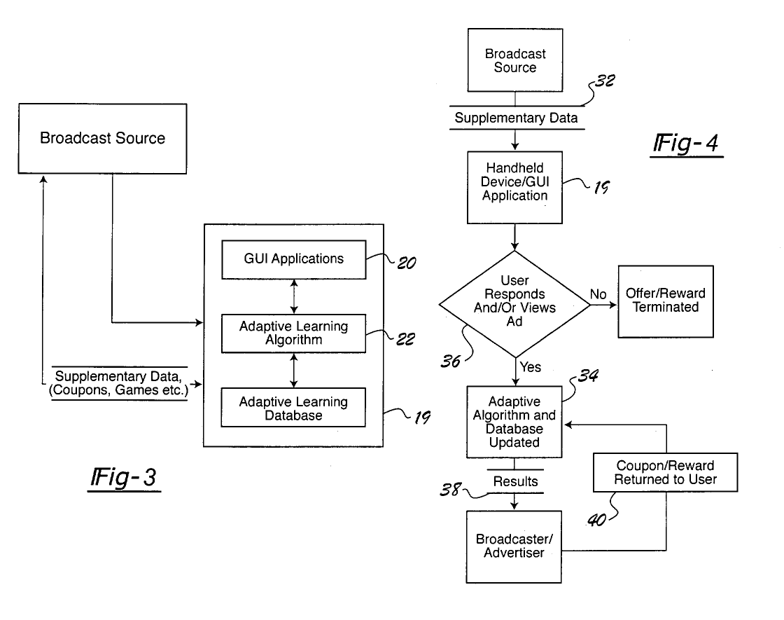

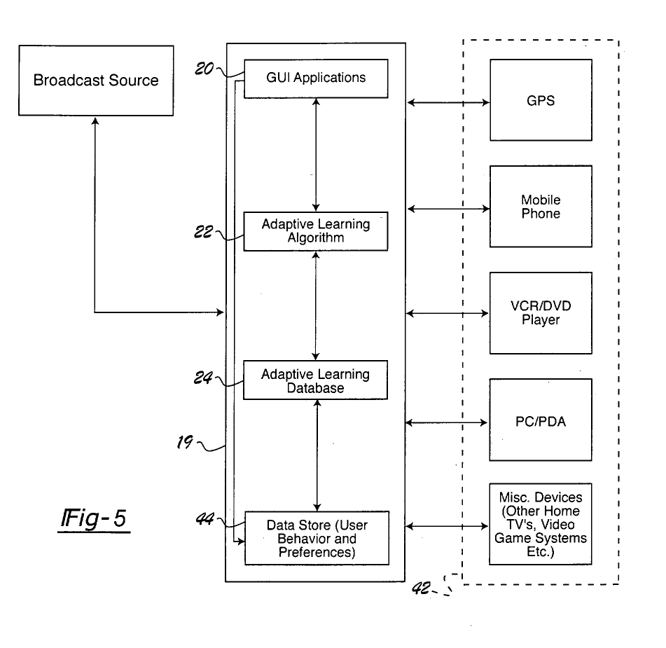

With reference to FIGS. 3 and 4, a method for enticing users to view an advertisement is described. When an advertisement broadcast begins, supplementary data 32 is routed through the interface unit and transmitted to the user via the handheld device 19. The data is presented to the user through the GUI application 20. This data 32 can take the form of coupons that are available upon completion of the commercial, extra information about the current advertisement, or interactive games that reward the user with free or discounted products. In another embodiment, a user may acquire points as at 34 for each viewing as at 36 of particular advertisements. Upon reaching certain point totals, a user may redeem as at 38 points for free or discounted products as at 40. In another embodiment, a user may qualify for a randomly awarded prize upon completion of the advertisement. In yet another embodiment, a user may gain access to products not normally advertised by viewing the entire commercial. This advertising data can be used in conjunction with the adaptive algorithm 22 to further determine the effects of the advertisements and the supplementary data 32 on viewership.

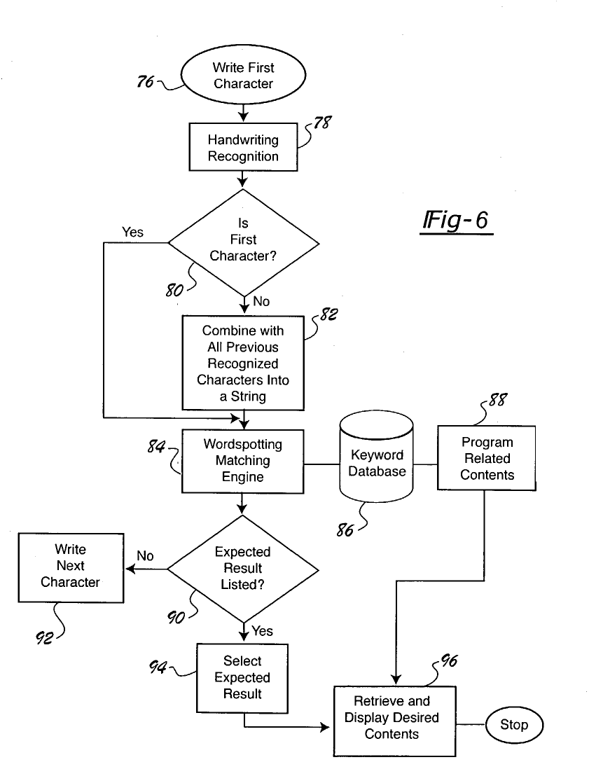

With reference to FIG. 5, a method for using the adaptive algorithm 22 to customize the behavior of the handheld device according to user viewing habits is described. The handheld device implements a data flow system architecture and a data store 44 to capture information about the user, such as prior viewing habits, channel selections, and other information indicative of the user's environment. This information can come from diverse sources 42 such as biometric sources and other digital data sources such as DVD players. The adaptive algorithm access the data store 44 and then customizes the performance of the device to better suit the user's needs. This customized performance may be realized in applications such as advertisements and supplementary program information. One possible application is GPS interaction to determine a user's travel habits. Another possible application is interaction with a DVD player to determine what types of movies a user typically watches. Yet another application is mobile telephone interaction to determine a user's general telephone usage. Based on user data gathered in this manner, the handheld device 19 can analyze this data in conjunction with the adaptive learning algorithm 22 and database 24. The device can then alter advertising content and offers, EPG format, the GUI application's 20 presentation, or command/request functions according to a user's typical behavior.

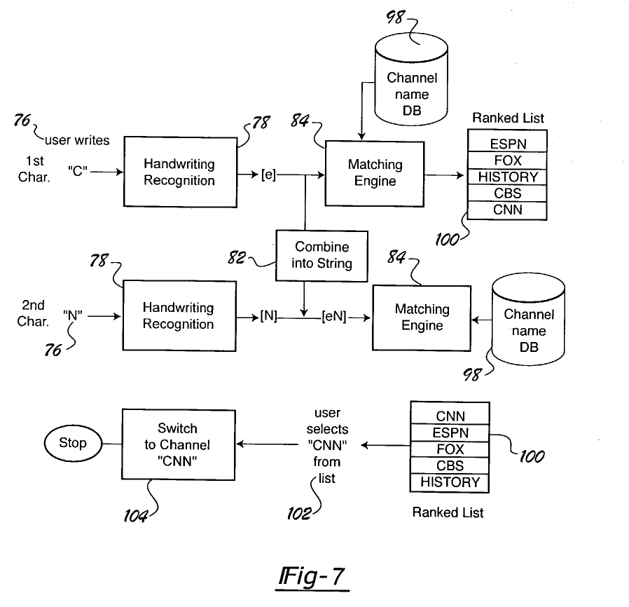

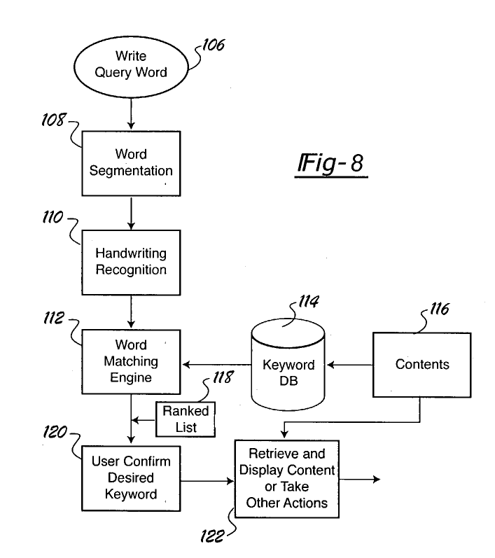

FIGS. 6-10 describe an adaptive handwriting search method according to the present invention, wherein the user writing behavior and user viewing behavior are used together to achieve a more efficient handwriting search of Electronic Programming Guide information, stored advertisements, and/or other information the user accesses via the handheld device. Operation of the handwriting interpreter 74 is described in detail in FIGS. 6 through 10. As seen in FIGS. 6 and 7, handwriting may be analyzed character by character using a progressive search. After first character 76 is written it is analyzed by a handwriting recognition device 78. Then the process proceeds directly to the word spotting matching engine 84 with one-character string. When the second character or subsequent characters are entered, previously analyzed characters are combined into a multi-character string 82. Once a group of characters have been assembled, the process proceeds to the word spotting and matching engine 84.

The word spotting and matching engine 84 compares the query string to keywords found in keyword database 86 formed from program related contents 88 to return a list of keywords approximating that entered by the user. The user must then scan the list of returned keywords to determine if the expected keyword or result is listed at step 90. If the expected keyword is not listed, the process proceeds to block 92 where the user is prompted to enter an additional character. The above process then repeats from step 78. If the expected result is listed, it is selected by the user at 94. The desired content associated with the handwritten entry is then obtained from the program related contents 88 at 96 and the character by character analysis of the handwriting input is complete.

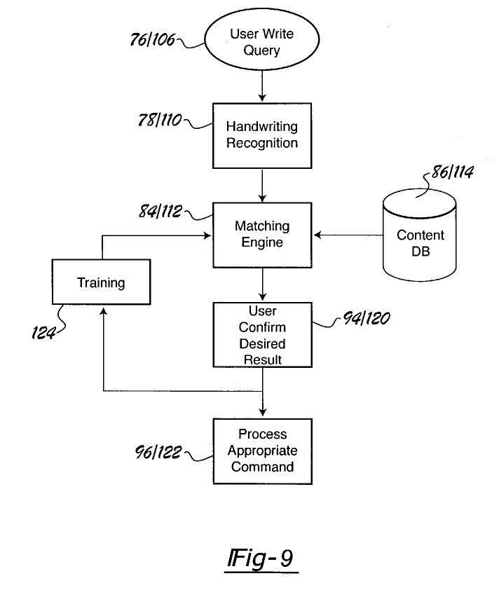

An example of a progressive search is illustrated in FIG. 8. As seen in FIG. 8, if a user desires to locate a particular channel and inputs the letter “e” at 76 and the character is recognized at 78, the methodology proceeds to word spotting matching engine 84. At word spotting matching engine 84 the recognized input is compared to the channel names within channel name database 98 to return ranked list 100. The user may then select the appropriate channel from the list 100 and the channel selected will be displayed. If the user input is not recognized, the input is combined into a string at 82 with an input 76 that is recognized at 78. The letters of the string are then associated with a channel name within channel database 98 by matching engine 84 to return ranked list 100. The user may then select the desired channel from the ranked list 100 at 102 and the selected channel will then be displayed at 104.

Handwriting may also be analyzed using a word-based search as illustrated in FIG. 8. After the user writes the word command at 106, the word undergoes segmentation at 108. The segmented word is then analyzed by handwriting recognition engine 110 and compared by word matching engine 112 to the words of keyword database 114, the words derived from program related contents 180. Word matching engine 112 then ranks the keywords of keyword database 114 according to the keywords that most closely approximate the query word 106 at 118. The user then confirms his/her desired keyword at 120 and the content associated with the user keyword is displayed at 122. Finally, any other actions associated with the entered keyword are also performed at 122.

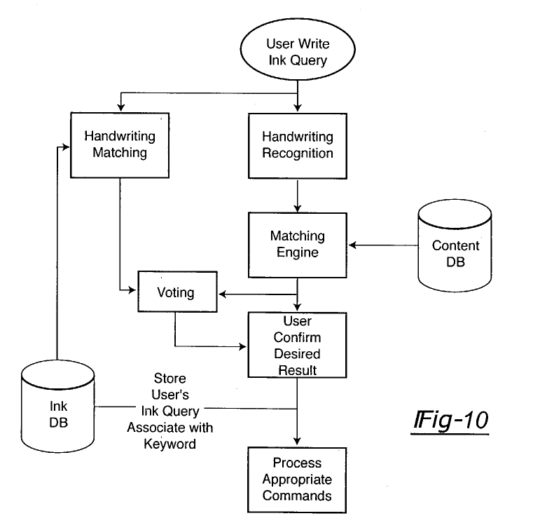

The handwriting interpreter 74 may also be self-training as seen in FIGS. 9 and 10. With reference to FIG. 9, training step 124 may be inserted into either the progressive search system (FIG. 6) or the word-based search system (FIG. 8). Specifically, at training step 124 the item selected by the user from the ranked list of results returned by the matching engine 84/112 is used to train the matching engine 84/112 to learn particular patterns of the handwriting recognition engine 78/110. These patterns may identify mistakes that the handwriting recognition engine 78/110 is likely to make, and consequently use such patterns to better guess when the handwriting recognition engine 78/110 generates invalid results. A simple example is that when handwriting recognition engine 78/110 often recognizes “c” as “e,” this pattern is learned and used next time by the matching engine 84/112. If confusion exists between “c” and “e”, the matching engine 84/112 can make a better guess based on the previous pattern it learned.

An additional hybrid self-training mechanism is illustrated in FIG. 10. The hybrid method employs the concept of self learning and records the user's previous handwriting query. When the user confirms a generated ranked list, his/her handwritten query is associated with the selected keyword text. For an incoming handwritten query, a handwritten recognition and a handwritten matching engine can be combined. The handwriting matching engine compares the handwritten query with previous handwritten queries, and finds the best match. Through a previous handwritten query that has been matched, its associated text keyword can be successfully located. The ink based handwriting matching is limited to user dependent matching and this limitation is resolved in the hybrid method, while a cursive handwritten query can also be handled. Further, the ink based handwriting matching requires user handwriting (ink database) to be entered in advance. When combining into the hybrid method, this ink database is accumulated through the self training process.

The description of the invention is merely exemplary in nature and, thus, variations that do not depart from the general substance of the invention are intended to be within the scope of the invention. Such variations are not to be regarded as a departure from the spirit and scope of the invention.

What is claimed is:

1. An adaptive learning system operable to learn and adapt to behavior of a user enjoying media content via a handheld device, comprising:
a communications interface adapted to receive media content;
a user interface provided to the handheld device and operable to receive user input;
a media delivery mechanism provided to said user interface and operable to deliver media content to the user in response to the user input; and
a data store provided to the handheld device and operable to record information relating to user consumption of media content via said handheld device.

2. The system of claim 1, wherein said communications interface is adapted to receive media content extracted from a broadcast signal.

3. The system of claim 1 comprising an adaptation module operable to adjust control of remotely controllable electronic media delivery devices according to the information.

4. The system of claim 1 comprising an adaptation module operable to adjust delivery of media content to the user based on the information.

5. The system of claim 1, wherein said communications interface is adapted to communicate the information to a provider of the media content.

6. The system of claim 1 comprising a learning module adapted to determine and record information including a user's position during the user consumption.

7. The system of claim 1 comprising a learning module adapted to acquire and record information relating to media enjoyed by a user via a remote media delivery device in communication with the handheld device.

8. The system of claim 1 comprising a learning module adapted to acquire and record information relating to a user's usage of a communication device in communication with the handheld device.

9. The system of claim 1 comprising:
an identification mechanism operable to identify the user; and
a user profile wherein the information relating to user consumption of media content is user-specific.

10. The system of claim 9, wherein said identification mechanism is operable to capture a user biometric relating to a mode of user input corresponding to at least one of voice, handwriting, and fingerprint.

11. The system of claim 1 comprising an adaptation module operable to adjust presentation of media content delivered to a user via said user interface based on the information.

12. The system of claim 1 comprising an adaptation module operable to adjust a format of an electronic programming guide delivered to the user via said user interface based on the information.

13. The system of claim 1 comprising an adaptation module operable to adjust at least one of appearance and function of said user interface based on the information.

14. The system of claim 1, wherein said user interface includes a handwriting interpreter adapted to combine user writing behavior and user viewing behavior to achieve a more efficient handwriting search.

15. A viewership augmentation system adapted to increase viewership of advertising content co-broadcast with programming content in a broadcast signal for use with a handheld device, comprising:
a user interface of the device delivering the advertising content to a user;
a delivery confirmation mechanism operable to make a determination that the user has received delivery of advertising content; and
a reward mechanism operable to reward the user based on the determination.

16. The system of claim 15, wherein the advertising content corresponds to an interactive game relating to at least one of an advertised product and an advertised service, and said reward mechanism is adapted to reward the user in connection with the user playing the game.

17. The system of claim 15, wherein said reward mechanism is adapted to accumulate points based on at least one of frequency and quantity of the user receiving delivery of advertising content, and adapted to reward the user when a sufficient number of points have been accumulated.

18. The system of claim 17, wherein said reward mechanism is adapted to permit the user to redeem accumulated points for a reward selected by the user from a plurality of available rewards.

19. The system of claim 17, wherein said reward mechanism is adapted to award a randomly selected reward to the user when a sufficient number of points have been accumulated, wherein the randomly selected reward is randomly selected from a plurality of available rewards.

20. The system of claim 15, wherein said reward mechanism is adapted to reward the user by providing the user with an electronic coupon providing a discount on at least one of a product and a service.

21. The system of claim 15, wherein said reward mechanism is adapted to reward the user by providing the user with an electronic coupon providing a discount on at least one of a product and a service advertised by the advertising content.

22. A method of learning and adapting to behavior of a user enjoying media content via a handheld device, comprising:
receiving user input via a user interface of the handheld device;
delivering media content to the user via said user interface in response to the user input; and
recording information relating to user consumption of media content in computer memory of the device, wherein the user consumption occurs in connection with said delivering electronic media content.

23. The method of claim 22 comprising adjusting control of remotely controllable electronic media delivery devices according to the information.

24. The method of claim 22 comprising adjusting delivery of media content to the user based on the information.

25. The method of claim 22 comprising communicating the information to a provider of the media content.

26. The method of claim 22 comprising determining and recording a user's position during the user consumption.

27. The method of claim 22 comprising acquiring and recording information relating to media enjoyed by a user via a media delivery device in communication with the handheld device.

28. The method of claim 22 comprising acquiring and recording information relating a user's usage of a communication device in communication with the handheld device.

29. The method of claim 22 comprising:
identifying the user;
maintaining a user profile wherein the information relating to user consumption of media content is user-specific.

30. The method of claim 29, including storing the user profile on at least one of the handheld device, a remote media consumption device, and a network in communication with the handheld device.

31. The method of claim 30, including sharing the user profile with other devices in communication with the network.

32. The method of claim 29 comprising identifying the user based on a user biometric relating to a mode of user input corresponding to at least one of voice, handwriting, and fingerprint.

33. The method of claim 22 comprising adjusting presentation of advertising content delivered to a user via a user interface of the handheld device based on the information.

34. The method of claim 22 comprising adjusting a format of an electronic program guide delivered to the user via a user interface of the handheld device based on the information.

35. The method of claim 22 comprising adjusting at least one of appearance and function of a user interface of the handheld device based on the information.

36. A method of increasing viewership of advertising content co-broadcast with programming content in a broadcast signal for use with a handheld device, comprising:
delivering the advertising content to a user of the device via a user interface of the device;
making a determination that the user has received delivery of advertising content; and
rewarding the user based on the determination.

37. The method of claim 36, comprising:
communicating an interactive game to the user, wherein the interactive game relates to at least one of an advertised product and an advertised service; and
rewarding the user in connection with the user playing the game.

38. The method of claim 36, comprising:
accumulating points based on at least one of frequency and quantity of the user receiving delivery of advertising content;
rewarding the user when a sufficient number of points have been accumulated.

39. The method of claim 38, comprising permitting a user to redeem accumulated points for an reward selected by the user from a plurality of available rewards.

40. The method of claim 38, comprising awarding a randomly selected reward to the user when a sufficient number of points have been accumulated, wherein the randomly selected reward is randomly selected from a plurality of available rewards.

41. The method of claim 36, comprising rewarding the user by providing the user with an electronic coupon providing a discount on at least one of a product and a service.

42. The method of claim 36, comprising rewarding the user by providing the user with an electronic coupon providing a discount on at least one of a product and a service advertised by the advertising content.
